(19) United States
(12) Patent Application Publication
(10) Pub. No.: US 2013/0201053 A1
(43) Pub. Date: Aug. 8, 2013

(54) Crash Avoidance System

(71) Applicant: Jeffrey Saing, Louisville, KY (US)

(72) Inventor: Jeffrey Saing, Louisville, KY (US)

(21) Appl. No.: 13/365,548

(22) Filed: Feb. 3, 2012

(51) Int. Cl. G01S 13/93

(52) U.S. Cl. 342/71

(57) ABSTRACT

A crash avoidance system is provided for a vehicle. The system utilizes thrusters to decrease the vehicle's velocity and brake time. The thrusters can also maneuver the vehicle from a possible crash. The system consists of a controller system which communicates with the thrusters that are strategically placed on the vehicle and at least one camera and radar sensors. The system also consists of an on-board pressurized gas source for the thrusters to produce a force to great and quick enough to avoid crashes. In case the driver loses traction and control for any reason, the system also communicates with the vehicle's traction control system.

### FIELD OF THE INVENTION

The present invention relates to a crash avoidance system for a vehicle, and more particularly, to a crash avoidance system for a vehicle which employs a thruster(s) supplied with on-board pressurized gas for producing a thrust force that quickly and safely maneuvers the vehicle to avoid a crash. The system utilizes radar and camera technology which a CPU uses to determine the probability of a crash or roll-over situation. The CPU will then, start and stop thrusters at the correct angle and power to avoid a crash and/or roll-over situation and safely return the vehicle to a manageable speed and situation where the driver has full control of the vehicle. This is very helpful if the vehicle loses traction due to weather conditions as well.

### BACKGROUND OF THE INVENTION

Auto manufacturers have developed crash sensing systems for years, such as rear view cameras and blind spot monitors. Some have also used radar combined with cameras to detect distance to an object and speed of your vehicle to determine probability of a crash. Once probability increases to a certain point, the system will alarm the driver with a sound and/or pre-pump your brakes to assist with braking. The radar and camera can also detect small objects in the road, even at night. This is the technology that will be used with this crash avoidance system(CAS) invention. This technology will be combined with thrusters to assist sudden braking and maneuvering of a vehicle to avoid a crash. Auto manufacturers have been developing automobiles that use alternate power sources to internal combustion engines for years now. Electrical vehicles having rechargeable batteries and hybrid vehicles using both internal combustion engines and electric motors for driving are becoming available for purchase. Electro-chemical fuel cells are also being developed to serve as an alternate source of electricity for powering electric drive motors of an automobile. An electro-chemical fuel cell contains a membrane sandwiched between electrodes. One preferred fuel cell is known as a proton exchange membrane(PEM) fuel cell, in which hydrogen is used as a fuel source or reducing agent at an anode electrode and oxygen is provided as the oxidizing agent at a cathode electrode. During operation of the fuel cell, electricity is garnered by electrically conductive elements proximate to the electrodes via the electrical potential generated during the reduction-oxidation reaction occurring within the fuel cell. For on-board vehicle fuel cell systems, the hydrogen can be stored in a pressurized tank that is typically between full fuel (for example, 10,000 p.s.i.) and low fuel (for example, 500 p.s.i.), depending upon the amount the tank is filled and the fuel is consumed.

### SUMMARY OF THE INVENTION

The present invention is directed to a crash avoidance system that is designed to maneuver a vehicle away from an imminent crash. The system includes thrusters mounted underneath a vehicle that are 360 degree maneuverable. The thrusters are in communication with a source of pressurized gas. The source of pressurized gas can either be pressurized hydrogen, which is also used with an on-board fuel cell, or a separate pressurized gas source. A controller system is provided for detecting potential crashes and releasing the pressurized gas from its source to the thrusters needed to avoid danger. The thrusters will produce a counteracting force of the vehicle's velocity in the appropriate angle to slow it down quicker and safer than brakes and tires. The controller system will utilize at least one camera and radar technology to detect potential hazards and the velocity and direction of an incoming object in a possible crash situation. The vehicle's traction control system will also communicate with the said controller system to alert the controller system of lost traction or control, so that the controller system can employ the thrusters need to safely regain control of the vehicle for the driver.

According to one aspect of the present invention, the controller system will communicate with the vehicle's camera(s), and/or radar, and traction control system while controlling the thrusters also. In this aspect, the thrusters are only mounted underneath the vehicle.

Further areas of applicability of the present invention may be possible. It should be understood that the description and examples, while indicating the preferred embodiment of the invention, are intended for illustration purposes only and are not intended to limit the scope of the invention.

### BRIEF DESCRIPTION OF THE DRAWINGS

FIG. 1 is a side view of a vehicle with the Crash Avoidance System. Thrusters are located underneath the vehicle in an inactivated state.

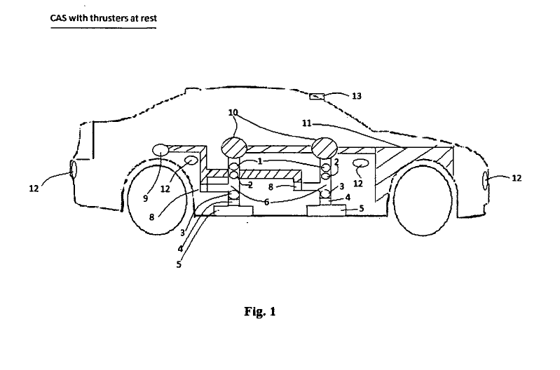

FIG. 2 is a side view of a vehicle with the Crash Avoidance System where the thrusters have been activated.

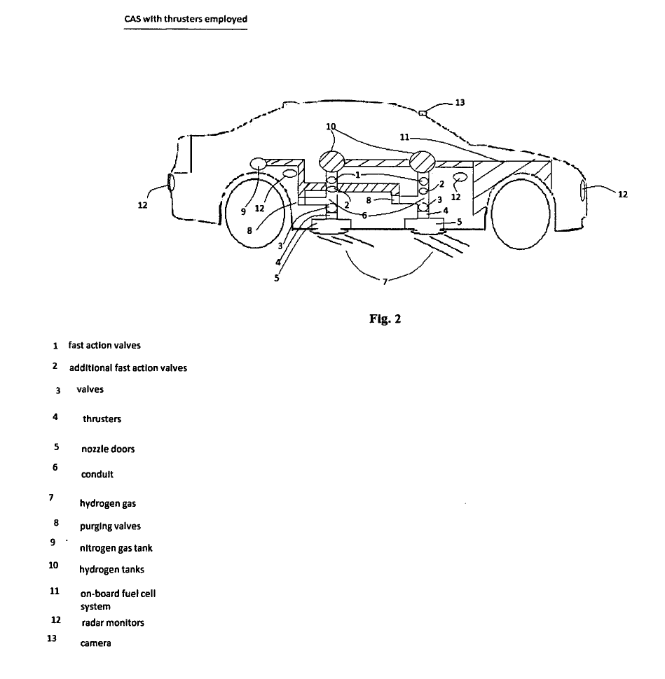

This substitute specification contains no new matter.

What is claimed is:

1. A crash avoidance system(CAS) for a vehicle (can be applicable to all vehicles). The system comprises of thruster(s) (number of thrusters may vary) mounted underneath the vehicle that are in communication with a source of pressurized gas (an on-board tank or fuel cell system) and a controller system for releasing pressurized gas from said source to said thruster(s). The system also comprises of a radar sensor(s) and camera(s) that work together to detect obstacles in the road or possible crashes. The radar sensor(s) and camera(s) determine if the vehicle could be in danger of a crash by determining distance of an object away from the vehicle and velocities of the vehicle and the object, if object is in motion. The sensor(s) and camera(s) then communicate with said controller system to start thrusters to avoid crashing. The thrusters will be 360 Degrees maneuverable. The vehicle's traction control system will also communicate with said controller system to employ thrusters when traction and control is lost.

2. The crash avoidance system according to claim 1, wherein said source of pressurized gas is stored hydrogen.

3. The crash avoidance system according to claim 1, wherein said source of pressurized gas is stored nitrogen.

4. A crash avoidance system for a vehicle, comprising: thruster(s) mounted on a vehicle and in communication with a source of pressurized gas; a controller system for releasing said pressurized gas and radar sensor(s) and camera(s) to detect possible crashes and a pressurized gas delivery system including a pressure regulator valve for allowing a regulated pressure level to accumulate in said pressurized gas delivery system downstream of a thruster nozzle, wherein said pressurized gas delivery system includes a secondary valve disposed upstream of said pressure regulator valve and downstream of said thruster nozzle, and said pressurized gas delivery system includes a tertiary valve disposed between said regulator valve and said secondary valve and further comprising a gas purging system for purging a portion of said pressurized gas delivery system between said secondary and tertiary valves; wherein said pressurized gas is an inert gas.

5. A method of avoiding a potential crash of a vehicle, comprising: mounting thruster(s) underneath a vehicle with said thrusters in communication with radar sensor(s), camera(s) and object/range detecting software, sensing vehicle conditions for detecting a potential crash, communicating with a source of pressurized gas that releases the pressurized gas to thruster(s) to generate a force to quickly maneuver the vehicle to avoid a crash; and purging pressurized gas from a gas delivery system downstream of thruster(s). The traction control system of the vehicle will also communicate with the vehicle's CPU to let the CPU know when traction or control is lost so that the CPU can employ the thrusters to avoid a crash and/or regain control of the vehicle for the driver.
